(19) United States
(12) Patent Application Publication
(10) Pub. No.: US 2026/0285564 A1
(43) Pub. Date: Sep. 24, 2026

(54) REINFORCED OBJECT BUNDLING SYSTEM

(71) Applicant: ABB Schweiz AG, Baden (CH)

(72) Inventor: Omar Alfredo Lopez, Nesbit, MS (US)

(21) Appl. No.: 19/085,470

(22) Filed: Mar. 20, 2025

(51) Int. Cl. B65D 63/10; B29C 45/14; B29L 31/00

(52) U.S. Cl. CPC B65D 63/1063; B29C 45/14819; B29L 2031/7276

(57) ABSTRACT

An object bundling system is described. The object bundling system includes an inner portion and an outer portion formed around the inner portion. The inner portion includes a head portion and a tail portion extending from the head portion. The outer portion includes a base formed around the head portion and a strap encompassing the tail portion to extend along a portion of a length of the strap. The base having a channel extending through the base. The strap is configured to be advanced through the channel in a first direction.

### TECHNICAL FIELD

The field of disclosure relates generally to object bundling systems, and more particularly, to a reinforced object bundling system having an inner portion that increases tensile strength of the object bundling system.

### BACKGROUND

Currently in the industry, cable ties fit into one of three categories: all-plastic cable ties, all-metal cable ties, and plastic cable ties with a metal locking pawl. These cable ties are used to collect and bundle objects intended for bundling such as cables, wires, or the like. These cable ties may comprise a strap that is adapted to be wrapped around the intended objects. The strap has a flexible, unitary body. In use, the strap is wrapped around the objects intended for bundling and one end of the strap is inserted through the opening, and pulled through the opening until the strap is pulled snugly against the objects. The strap includes outwardly directed locking members that impede loosening displacement of the strap end in a second direction, and as a result the locking members maintain the strap snugly against the objects. Over time, the weight of the bundled objects against the strap causes the locking members to degrade or fail, resulting in strap loosening or a releasing of the previously secured objects.

These existing cable ties also may not meet the needs for users under certain conditions. For example, existing cable ties are made from specified materials to ensure the cable ties possess the necessary amount of tensile strength required to effectively secure the bundle objects. However, in use these materials may be exposed to extreme weather and/or corrosive substances. Although the existing cable ties may possess the requisite tensile strength, the cable ties may not possess the necessary properties to withstand the exposure to such extreme weather and/or corrosive substances or be environmentally friendly.

Based on the foregoing, a need exists for a reinforced object bundling system that includes two different locking mechanisms to maintain locking of the object bundling system and can be made from more environmentally friendly and/or materials with desired properties while maintaining a strength that is comparable to existing solutions.

This background section is intended to introduce the reader to various aspects of art that may be related to various aspects of the present disclosure, which are described and/or claimed below. This discussion is believed to be helpful in providing the reader with supporting information to facilitate a better understanding of the various aspects of the present disclosure. Accordingly, it should be understood that these statements are to be read in this light, and not as admissions of prior art.

### BRIEF DESCRIPTION

In one aspect, an object bundling system is described. The object bundling system comprises an inner portion comprising a head portion and a tail portion extending from the head portion. The object bundling portion also comprises an outer portion formed around the inner portion. The outer portion comprises a base formed around the head portion, the base having a channel extending through the base and a strap encompassing the tail portion to extend along a portion of a length of the strap, the strap being configured to be advanced through the channel in a first direction.

In another aspect, an object bundling system is described. The object bundling system comprises an inner portion comprising a first piece further comprising a head portion defining an opening and a barb integrally formed with the head portion, the barb extending into the opening. The inner portion further comprises a tail piece attached to the head portion. The object bundling system further comprises an outer portion formed around the inner portion. The outer portion comprises a strap encompassing the tail piece to extend along a portion of a length of the strap, the strap having at least one engagement member along the strap surface. The outer portion further comprises a base disposed at an end of the strap, the base formed around the head portion, wherein the base includes a channel extending through the base and a base engagement member projecting into the channel, the base engagement member is configured to interlock with the strap as the strap is advanced through the channel in a first direction and the barb extends through the base into the channel and opposes the base engagement member.

In yet another aspect, a method of manufacture for an object bundling system is described. The method comprises locating an inner portion for the object bundling system within a mold, the inner portion comprising a head portion, a barb integrally formed with the head portion, and a tail portion extending away from the head portion; closing the mold; injecting a first material into the mold; and forming an outer portion of the object bundling system with the first material. The outer portion comprises a strap encompassing the tail piece to extend along a portion of a length of the strap, the strap having at least one engagement member along the strap surface. The outer portion also comprises a base disposed at an end of the strap, the base formed around the head portion, wherein the base includes a channel extending through the base and a base engagement member projecting into the channel, the base engagement member is configured to interlock with the strap as the strap is advanced through the channel in a first direction and the barb extends through the base into the channel and opposes the base engagement member.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts a perspective view of a first embodiment of an inner portion for a reinforced object bundling system;

FIG. 2A depicts a perspective view of a first side and first surface of a reinforced object bundling system including the first embodiment of an inner portion of FIG. 1;

FIG. 2B depicts a perspective view of a second side and second surface of the reinforced object bundling system of FIG. 2A;

FIG. 3 depicts a cross-sectional view of the base and the portion of the strap of the reinforced object bundling system of FIGS. 2A and 2B taken along line 3-3 in FIG. 2A;

FIG. 4 depicts a rear view of a base and a portion of a strap of the reinforced object bundling system of FIGS. 2A and 2B;

FIG. 5 depicts a cross-sectional view of the strap of the reinforced object bundling system of FIGS. 2A and 2B along line 5-5 in FIG. 4;

FIG. 6 depicts a perspective view of the reinforced object bundling system of FIGS. 2A and 2B with a strap inserted into a base of the reinforced object bundling system;

FIG. 7 depicts a perspective view of a second embodiment of an inner portion for the reinforced object bundling system of FIGS. 2A and 2B; and

FIG. 8 depicts a flowchart of an exemplary method of manufacture for an object bundling system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

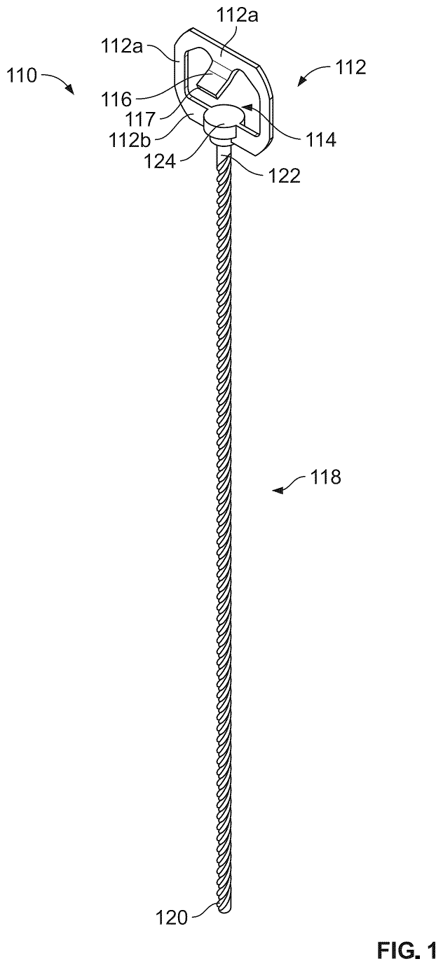

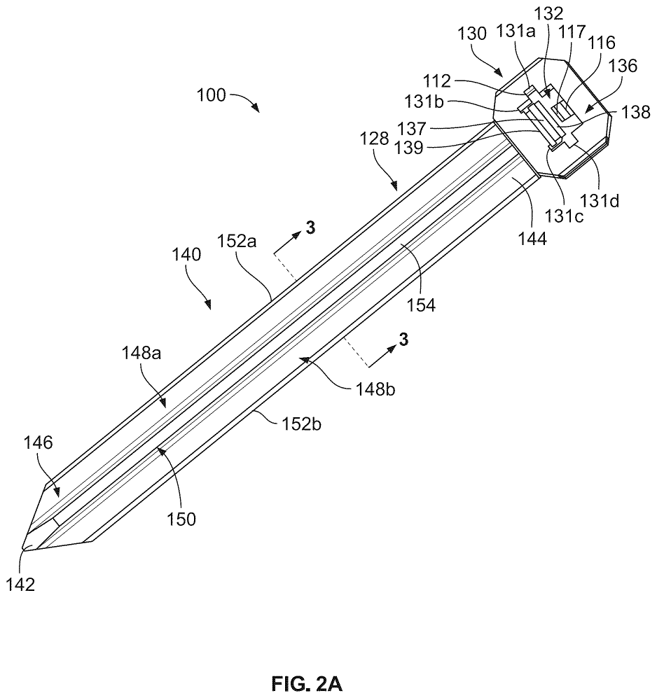

FIG. 1 depicts a perspective view of a first embodiment of an inner portion 110 for a reinforced object bundling system 100 (shown in FIGS. 2A-6). The inner portion 110 includes a head portion 112. The head portion 112 defines an opening 114 extending through the head portion 112. The head portion 112 of the inner portion 110 additionally includes a barb 116 integrally formed with the head portion 112. For example, as shown in FIG. 1, the barb 116 is formed along a first portion 112a of the head portion 112. However, the barb 116 may be formed along any portion of the head portion 112, such as along second portion 112b. In the illustrated embodiment, the head portion 112 includes a single barb 116, however it is understood that the inner portion 110 may include a plurality of barbs 116.

The inner portion 110 also includes a tail portion 118 extending from the head portion 112. The tail portion 118 is elongate and includes a first free end 120, that is distal from the head portion 112, and a second end 122 that is attached to the head portion 212. The inner portion 110 may be a 2-piece construction. The head portion 112 and the tail portion 118 may be discrete members manufactured separately and the tail portion 118 may be mechanically attached to the head portion 112 by a tail head 124 by soldering, mating features, or the like. The head portion 112 and the tail portion 118 may each be made of a single metal material, such as 304 stainless steel, 316 stainless steel, or the like. In some embodiments, the head portion 112 may be made of a first metal material, such as a stainless steel or the like, and the tail portion 118 may be made of a second metal material, such as braided steel wire or the like.

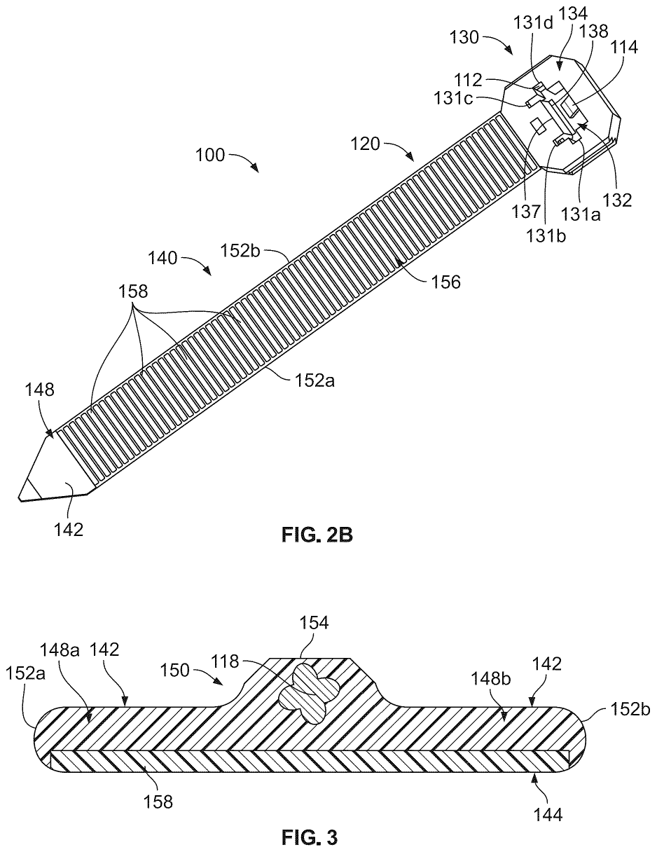

FIG. 2A depicts a reinforced object bundling system 100 including the first embodiment of an inner portion of FIG. 1, showing a first surface 142 of a strap 140 of an outer portion 128 of the reinforced object bundling system 100. FIG. 2B depicts a second perspective view of the reinforced object bundling system 100 of FIG. 2A, showing a second surface 144 of the strap 140. FIG. 3 depicts a cross-sectional view of the strap of the reinforced object bundling system of FIGS. 2A, 2B, and 3 along line 3-3 of FIG. 2A.

The reinforced object bundling system 100 includes an inner portion 110, as described above, and an outer portion 128 formed around the inner portion 110. The inner portion 110 provides additional structure to increase the tensile strength of the reinforced object bundling system 100. The tensile strength of the reinforced system 100 is measurably greater than the tensile strength of a similar bundling system that does not include the inner portion 110. By including the inner portion 110 in bundling system 100, additional materials may be used to form the outer portion where the materials comprise the material properties required to withstand the exposure to extreme weather and/or corrosive substances and are environmentally friendly. Accordingly, the outer portion 128 may be made from materials with desired chemical resistance properties and may include polypropylene (PP), polyethylene (PE), high-density polyethylene (HDPE), low-density polyethylene (LDPE), polyethylene terephthalate (PET) and recycled materials may include fully recycled versions of polypropylene (PP), polyethylene (PE), high-density polyethylene (HDPE), low-density polyethylene (LDPE), polyamide 6 (PA6), polyamide 66 (PA66), or the like.

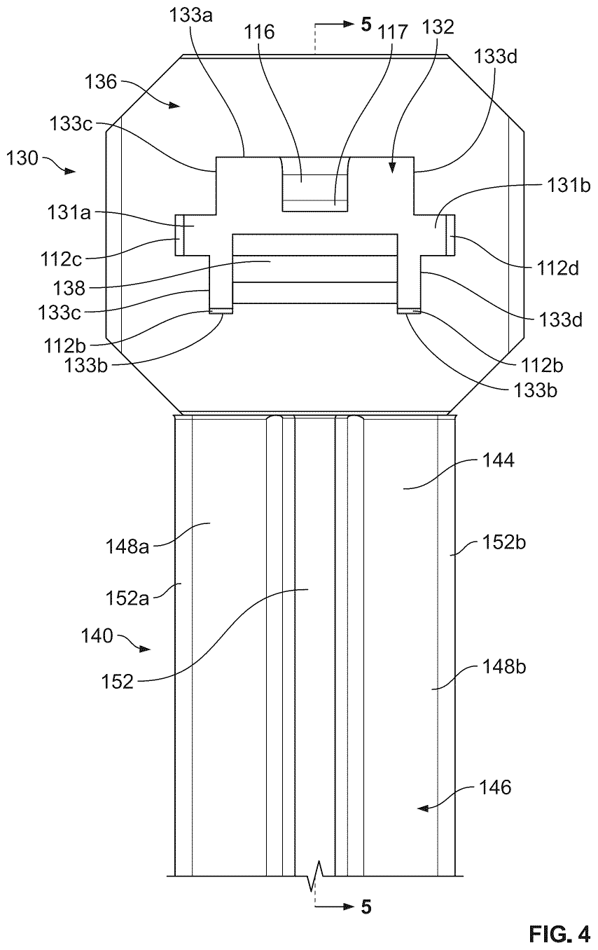

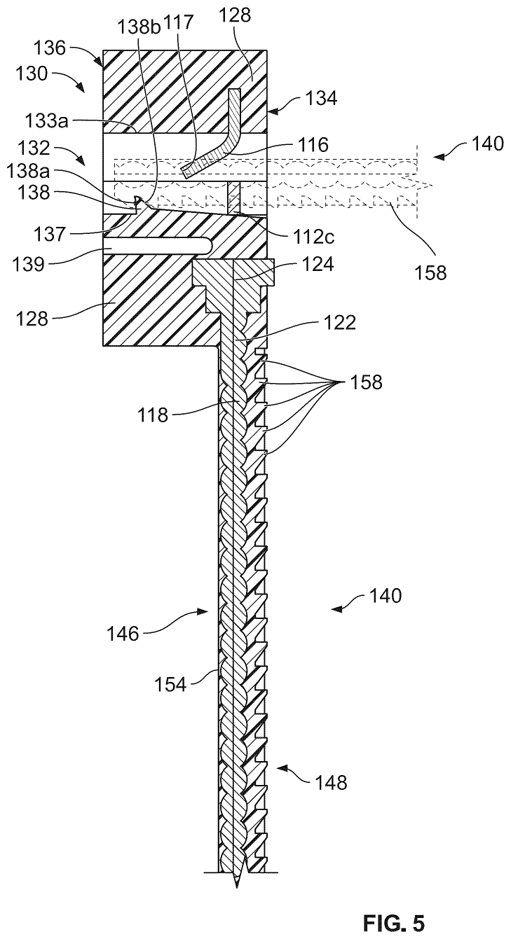

The outer portion 128 comprises a base 130 and a strap 140. The base 130 is formed over the head portion 112 of the inner portion 110, such that the base 130 encompasses at least a portion of the head portion 112. For example, the base 130 may be formed over the head portion 112 such that portions of the head portion 112, such as portions 112b, 112c, 112d (shown in FIG. 4), extend into inlets 131a, 131b, as well as past channel wall 133b of the base 130 and are exposed within a channel 132. In some embodiments, the base 130 may be formed over the head portion 112 such that the base 130 completely encompasses head portion 112. The base 130 defines the channel 132 that extends through the base 130 and the opening 114 of the inner portion 110. As shown in FIG. 5, the barb 116 of inner portion 110 also extends through the base 130 and into the channel 132 such that the barb 116 is exposed within the channel 132.

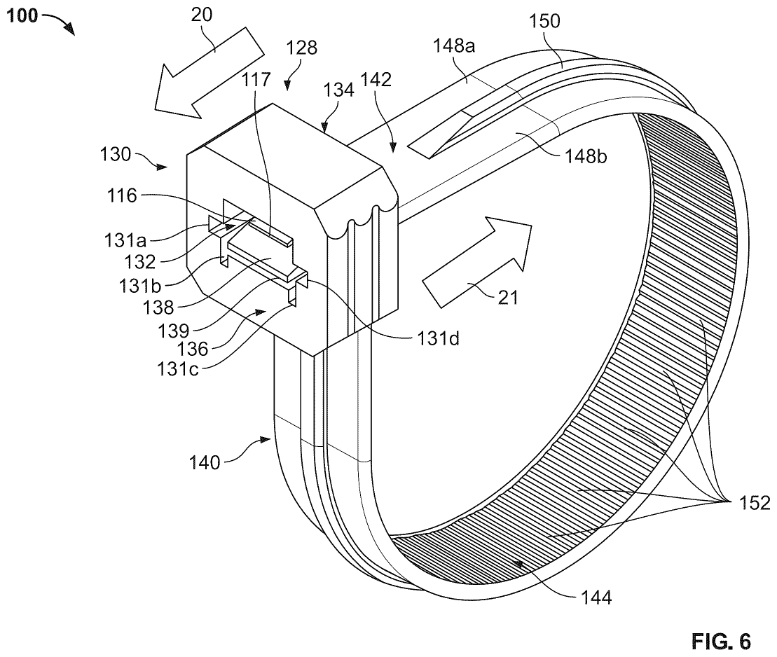

The base 130 includes an insertion end 134 and a removal end 136 opposite the insertion end 134. The insertion end 134 is configured to receive the strap 140 to allow the strap 140 to be inserted into and passed through the channel 132 towards the removal end 136, as described in more detail below with reference to FIG. 6, to allow the strap 140 to be tightened around objects intended for bundling.

The strap 140 is formed over the tail portion 118 of the inner portion 110 such that the strap 140 encompasses the tail portion 118. For example, the strap 140 may be formed over the tail portion 118 such that the tail portion 118 is completely disposed within, and extends along, a portion of the length of the strap 140. The strap 140 is elongate and includes a first free end 142, that is distal from the base 130, and a second end 144 that is made integral with the base 130. The tail portion 118 of the inner portion 110 provides additional structure for the strap 140 in addition to the associated increase in tensile strength of the strap 140.

The strap 140 includes a first surface 146 and a second surface 148. The strap 140 includes first surface 146 of the strap 140 and a medial portion 150 that protrudes from the first surface 146 along the length of the strap 140. Defined between the medial portion 150 and the opposed peripheral edges 152a, 152b of the strap are lateral portions 148a, and 148b. The medial portion 150 extends longitudinally, along the first surface 146, from the base 130, as shown in FIG. 4 and terminates proximate the free end/insertion end 142 of the strap 140.

The medial portion 150 may comprise a raised rib 154 that extends along a portion of the length of the strap 140. As shown in FIG. 3, the longitudinal rib 154 protrudes from the first surface 146. The longitudinal rib 154 may be formed over the tail portion 118 of internal portion 110 such that the longitudinal rib 154 encompasses the tail portion 118 of the inner portion 110 (shown in FIG. 3), and as formed produces the rib's raised structure relative to surface 146. For example, the longitudinal rib 154 is formed around the outermost boundary and the entire length of the tail portion 118. In some embodiments, a length of the longitudinal rib 154 may correspond to a length of the tail portion 118. Alternatively, in some embodiments, the longitudinal rib 154 may extend at a length that is greater than the length of tail portion 118. As explained in further detail below with reference to FIG. 6, when the strap is moved in the direction 20 and thereby located in the channel 132, the barb 116 is configured to contact the rib 154. Additionally, the barb 116 is configured to pierce the longitudinal rib 154 and engage the tail portion 118 of the inner portion 110 when a force is applied to the strap 140 in a second direction 21 (shown in FIG. 6), that is opposite of the direction of insertion 20 (shown in FIG. 6). As a result, the bundling system 100 thereby prevents unintended and undesirable translation of the strap 140 through the channel 132 in direction 21.

The strap 140 includes a second surface 148, that is opposed to the first surface 146. The second surface 148 extends longitudinally from the base 130 to the end of the strap 140 and the second surface is defined along the periphery by opposed first edge 152a and second edge 152b.

A plurality of engagement members 158 are formed along the length of the second surface 148. The engagement members extend from the base 13 as shown in FIG. 2B and between the first edge 152a and second edge 152b. The engagement members terminate proximate the strap free end 142. The engagement members 158 extend laterally. Although the engagement members 158 are shown extending from the base 130 and terminating proximate end 149, it should be understood any configuration of engagement members may be included on second surface 148, and for example may extend fully to the end 149 of the strap 140. As explained in further detail below with reference to FIG. 6, the plurality of lateral engagement members 158 of the strap 140 are configured to interlock with at least one base engagement member 138 of the base 130. However only one of the engagement members 158 will engage the member 138 to prevent translation of the strap in direction 21. The engagement between members 138 and 158 in combination with barb 116 piercing rib 154 effectively prevents undesirable displacement of strap 140 in direction 21. Including the engagement members along the length of the strap enables the strap 140 to effectively bundle and secure a groups of objects of varying circumferential dimensions. For example, where objects comprise smaller circumferential dimensions, engagement of member 138 will be made by a member 158 proximate base 130, and for objects that comprise a larger circumferential dimensions, engagement of member 138 will be made by members 158 proximate strap end 149. In some embodiments, the plurality of lateral engagement members 158 of the strap 140 are barbed teeth that each interlock or engage with at least one base engagement member 138 of the base 130. In some embodiments, plurality of lateral engagement members 158 are configured as a ratcheting mechanism, where the plurality of lateral engagement members 158 allow the strap 140 to be advanced in the direction of insertion 20, but prevent the strap 140 from advancing in the second direction 21 by the engagement between the lateral engagement members 158 and base engagement member 138.

FIG. 4 depicts the base 130 and a portion of the strap 140 of the reinforced object bundling system 100 of FIGS. 1A, 1B, and 2. FIG. 5 depicts a cross-sectional view of the strap of the reinforced object bundling system of FIGS. 1A, 1B, and 2 along line 5-5 in FIG. 4, showing the strap 140, in phantom, inserted into the channel 132 and engaging the engagement member 138. The base 130 also includes a first channel wall 133a, a second channel wall 133b, a first lateral side 133c, and a second lateral side 133d. The first channel wall 133a, second channel wall 133b, first lateral side 133c, and second lateral side 133d extend between the insertion and removal ends 134 and 136. The base 130 may include a first inlet 131a that is formed into the first lateral side 133c and a second inlet 131b that is formed into the second lateral side 133d. The first inlet 131a and the second inlet 131b each extend between the insertion and removal ends 134 and 136 to allow the channel 132 to receive the strap 140. The inlets 131a, 131b enables channel 13 to accommodate straps having varying lateral dimensions. The first channel wall 133a, second channel wall 133b, first lateral side 133c, second lateral side 133d, the first inlet 131a, and the second inlet 131b collectively define the channel 132. The channel 132 extends through the base 130 from the insertion end 134 to the removal end 136, and the strap 140 is configured to be advanced through the channel 132 from the insertion end 134 of the base 130 in the first direction 20 (shown in FIG. 6).

As shown in FIGS. 4 and 5, the barb 116 extends through first channel wall 133a and into the channel 132. The barb 116 may be oriented such that the engagement end 117 of the barb 116 extends towards removal end 136 of the base 130. As shown in FIG. 5, the barb 116 may be disposed proximate to the insertion end 134 of the base 130 relative to the at least one base engagement member 138. As will be explained in further detail below, the orientation of the barb 116 allows the barb 116 to engage the strap 140 and/or tail portion 118 when a force is applied to the strap 140 in the second direction 21.

As shown in FIG. 5, a groove 139 is formed in base 130. The groove has an open end formed on removal end 136 and has a closed end in the base. Including the groove in the base enables the engagement member 138 and flexible member 137 that supports the engagement 138 to flex toward and away from barb 116 as the strap is passed through the chamber 132. In the illustrated embodiments, as a result of groove the flexible member 137 is a cantilevered member. As will be explained in further detail below, the flexible member 137 is configured to flex away from the strap when the strap is inserted and also conversely flex toward the strap upon insertion to thereby apply a biasing force against the strap 140 such that the flexible member 137 is urged towards the strap 140 and thereby maintains engagement between at least one base engagement member 138 and the strap engagement members 158. Further, the strap 140 is urged into engagement with the barb 116 when a force is applied to the strap 140 in the second direction 21.

The base 130 includes at least one base engagement member 138 disposed on the flexible member 137 and extending into the channel 132. As shown in FIG. 5, the at least one base engagement member 138 is located along surface 133b and extends into channel 132. The barb 116 extends into channel 132 through surface 133a, opposite the surface 133b. As result the ends of the engagement member 138 and barb 116 are opposed. The opposed orientation enables bundle locking provided by system 100. As shown in FIG. 5, the at least one base engagement member 138 may be disposed proximate to the removal end 136 of the base 130 relative to the barb 116. As best shown in FIGS. 4 and 5, in some embodiments, the at least one base engagement member 138 includes a holding surface 138a and a leading surface 138b (shown in FIG. 5). In some embodiments, the holding surface 138a is substantially perpendicular to flexible member 137. The leading surface 138b is oriented at an angle of less than ninety degrees relative to the holding surface 138a.

FIG. 6 depicts a perspective view of the reinforced object bundling system of FIGS. 2A and 2B with the strap 140 partially inserted into the channel 132 of the base 130 of the reinforced object bundling system 100. In operation, the strap 140 is advanced in the first direction 20 until the strap 140 is snugly wrapped around objects intended for bundling and cinched to a desired torque or holding force, or until the strap 140 can no longer be advanced in the first direction 20. Subsequently, applying a force to the strap 140 in the second direction 21, that is opposite the first direction 20, causes one of the lateral engagement members 158 of the strap 140 to engage the holding surface 138a of base engagement member 138 and provide a lock to prevent unintended translation of the strap 140 through the channel 132 in direction 21. The flexible member 137 is configured to apply a biasing force against the strap 140 upon insertion of the strap 140 into the channel 132, such that the base engagement member 138 is biased against the strap 140. Applying a force on the strap 140 in the second direction 21 also causes the barb 116 to pierce the longitudinal rib 154, as shown in FIG. 5. Subsequently, once the barb 116 pierces the longitudinal rib 154, the barb 116 may also engage the tail portion 118 of the inner portion 110 and the barb 116 may be pressed against the tail portion 118 to provide an additional lock to further prevent unintended translation of the strap 140 through the channel 132, thereby impeding loosening translation of strap 140 in the second direction 21.

As the first free end 142 of the strap 140 is inserted into the channel 132 of the base 130, the plurality of lateral engagement members 158 from the first end 142 to the second end 144 of the strap 140 sequentially traverses the leading surface 138b of the base engagement member 138 and one of the lateral engagement members 158 interlocks with the holding surface 138a of the base engagement member 138, as shown in FIG. 5. In the illustrated embodiment, the base 130 includes a single engagement member 138 which forms the ratcheting mechanism, however it is understood that a plurality of strap engagement members 138 may form the ratcheting mechanism together with the plurality of lateral engagement members 158 of the strap 140.

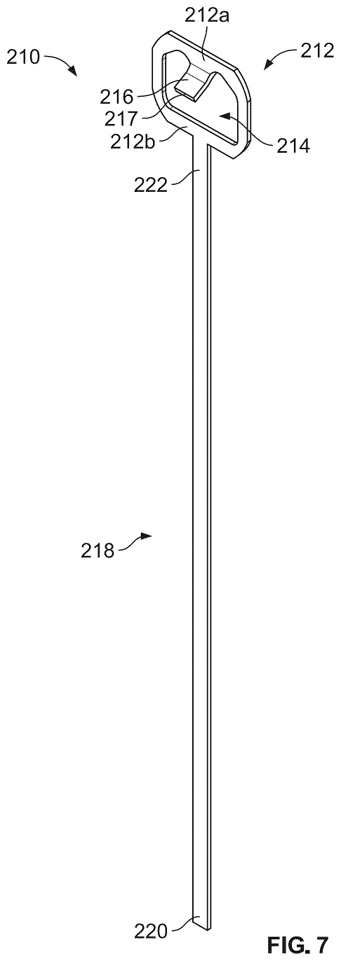

FIG. 7 depicts a perspective view of a second embodiment of an inner portion 210 for the reinforced object bundling system 100. Alternatively, in some embodiments, the reinforced object bundling system 100 may include inner portion 210 in place of inner portion 110. The inner portion 210 includes a head portion 212. The head portion 212 defines an opening 214 extending through the head portion 212. The inner portion additionally includes a barb 216 integrally formed on the head portion 212. For example, as shown in FIG. 7, the barb 216 is formed along a first portion 212a of the head portion 212. However, the barb 216 may be formed along any portion of the head portion 212, such as along second portion 212b. The inner portion also includes a tail portion 218 extending from the head portion 212. The tail portion 218 is elongate and includes a first free end 220, that is distal from the head portion 212, and a second end 222 that is made integral with the head portion 212. The inner portion 210 may be a single piece construction formed from single piece of material. For example, each of the head portion 212, the barb 216, and the tail portion 218 may be stamped from a single sheet of metal using a die. The inner portion 210 may be made from a metal material, such as 304 stainless steel, 316 stainless steel, or the like. The bundling system 100 that includes inner portion 210 includes the features and elements and characteristics previously described in relation to the bundling system 100 that includes inner portion 110.

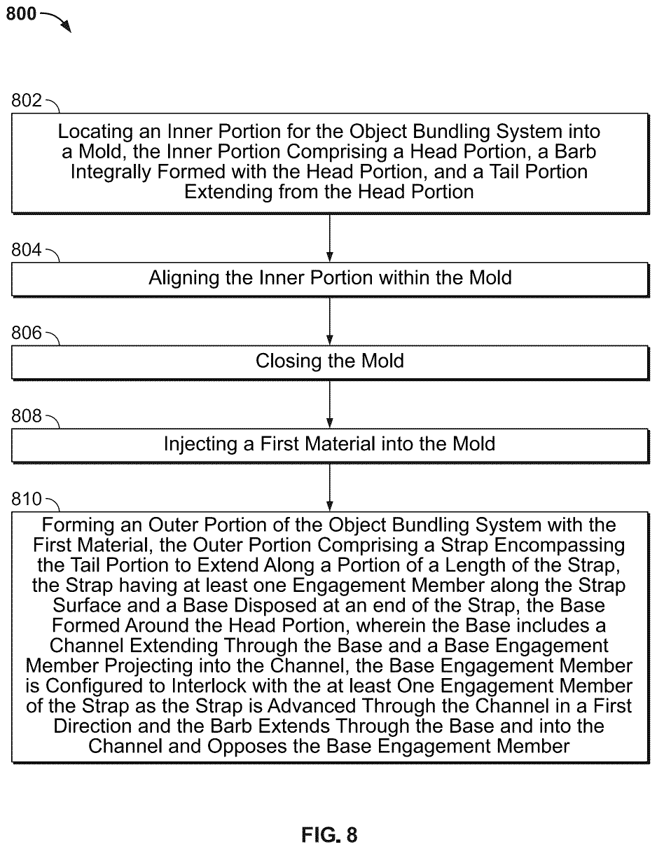

FIG. 8 is a flowchart of an exemplary method 800 of manufacture for an object bundling system 100. At 802, the method 800 includes locating an inner portion 110, 210 for the object bundling system 100 within a mold (not shown). The inner portion 110, 210 comprising a head portion 112, 212, a barb 116, 216 integrally formed with the head portion 112, 212, and a tail portion 118, 218 extending away from the head portion 112, 212. In some embodiments, the method 800 may include forming the head portion, the barb, and the tail portion from a single piece of a material. In some embodiments, the head portion 112 and barb 116 be a first piece made of a metal material and the tail portion 118 may be a second piece and be made of a separate metal material and the method 800 may include attaching the tail portion 118 to the head portion 112 prior to insertion into the mold. At 804, the method 800 includes closing the mold.

At 806, the method 800 includes injecting a first material into the mold. In some embodiments, the first material may be a material with desired chemical resistance properties, recycled materials, or the like. For example, materials with desired chemical resistance properties may include polypropylene (PP), polyethylene (PE), high-density polyethylene (HDPE), low-density polyethylene (LDPE), polyethylene terephthalate (PET) and recycled materials may include fully recycled versions of polypropylene (PP), polyethylene (PE), high-density polyethylene (HDPE), low-density polyethylene (LDPE), polyamide 6 (PA6), polyamide 66 (PA66), or the like.

At 808, the method 800 includes forming an outer portion 128 of the object bundling system 100 with the first material. The outer portion 128 comprises a base 130 formed around the head portion 112, 212 and the barb 116, 216. The base 130 includes a channel 132 extending through the base 130 and the barb 116, 216 extends through the base 130 and into the channel 132. The outer portion 128 also comprises a strap 140 encompassing the tail 118, 218 portion such that the tail portion 118, 218 extends along a portion of a length of the strap 140. The strap 140 is configured to be advanced through the channel 132 in a first direction 20. The strap 140 includes a first surface 146 and a second surface 148. In some embodiments, forming the outer portion 128 may comprise forming a plurality of lateral engagement members 158 on the second surface 148 of the strap, wherein a base engagement member 138 within the channel 132 engages each of the plurality of lateral engagement members 158 when the strap 140 is translated though the channel 132 in the first direction 20 to provide a first lock for the strap.

In some embodiments, forming the outer portion 128 comprises forming a longitudinal rib 154 to encompass the tail portion 118, 218 along the portion of the length of the strap 140 on the first surface 146 of the strap 140. The barb 116, 216 is configured to pierce the longitudinal rib 152 when a force is applied to the strap 140 in the second direction 21 to provide a lock for the strap. The barb 116, 216 may be configured to engage the tail portion 118, 218 when the barb 116, 216 pierces the longitudinal rib 152.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An object bundling system comprising:
an inner portion comprising:
a head portion;
and
a tail portion extending from the head portion; and
an outer portion formed around the inner portion, the outer portion comprising:
a base formed around the head portion, the base having a channel extending through the base;
a strap encompassing the tail portion to extend along a portion of a length of the strap, the strap being configured to be advanced through the channel in a first direction.

2. The object bundling system of claim 1, wherein the inner portion further comprises a barb integrally formed with the head portion, wherein the barb extends through the base and into the channel.

3. The object bundling system of claim 2, wherein the strap includes a first surface and a second surface, the strap including a rib located along the first surface and extending along a portion of the length of the strap, and at least one engagement member located along the second surface.

4. The object bundling system of claim 3, wherein the rib covers the tail portion of the inner portion.

5. The object bundling system of claim 3, wherein the barb is oriented such that when a force is applied to the strap in a second direction, the barb pierces the rib and engages the rib.

6. The object bundling system of claim 3, wherein the at least one engagement member comprises a plurality of lateral engagement members.

7. The object bundling system of claim 6, wherein the base comprises a base engagement member projecting into the channel and opposing the barb, the base engagement member is configured to interlock with each of the plurality of lateral engagement members as the strap is advanced in the first direction.

8. The object bundling system of claim 1, wherein the inner portion is a single piece.

9. The object bundling system of claim 1, wherein the head portion and the barb are a first piece of the inner portion and the tail portion is a second piece of the inner portion.

10. An object bundling system comprising:
an inner portion comprising:
a first piece comprising:
a head portion defining an opening; and
a barb integrally formed with the head portion, the barb extending into the opening; and
a tail piece attached to the head portion; and
an outer portion formed around the inner portion, the outer portion comprising:
a strap encompassing the tail piece to extend along a portion of a length of the strap, the strap having at least one engagement member along the strap surface; and
a base disposed at an end of the strap, the base formed around the head portion, wherein the base includes a channel extending through the base and a base engagement member projecting into the channel, the base engagement member is configured to interlock with the at least one engagement member as the strap is advanced through the channel in a first direction and the barb extends through the base into the channel and opposes the base engagement member.

11. The object bundling system of claim 10, wherein the strap includes a first surface and a second surface, the strap including a rib located along the first surface and extending along a portion of the length of the strap, and the at least one engagement member located along the second surface.

12. The object bundling system of claim 11, wherein the rib covers the tail portion of the inner portion.

13. The object bundling system of claim 12, wherein the barb is oriented such that when a force is applied to the strap in a second direction, the barb pierces the rib and engages the rib.

14. The object bundling system of claim 10, wherein the head portion and the barb comprise a first material and the tail portion comprises a second material.

15. A method of manufacture for an object bundling system, the method comprising:
locating an inner portion for the object bundling system within a mold, the inner portion comprising a head portion, a barb integrally formed with the head portion, and a tail portion extending from the head portion;
closing the mold;
injecting a first material into the mold; and
forming an outer portion of the object bundling system around the inner portion with
the first material, the outer portion comprising:
a strap encompassing the tail piece to extend along a portion of a length of the strap, the strap having at least one engagement member along the strap surface; and
a base disposed at an end of the strap, the base formed around the head portion, wherein the base includes a channel extending through the base and a base engagement member projecting into the channel, the base engagement member is configured to interlock with the at least one engagement member of the strap as the strap is advanced through the channel in a first direction and the barb extends through the base into the channel and opposes the base engagement member.

16. The method of claim 15, further comprising forming the head portion, the barb, and the tail portion from a single piece of a second material.

17. The method of claim 15, wherein the head portion and barb comprise a second material and the tail portion comprises a third material and the method further comprises attaching the tail portion to the head portion prior to insertion into the mold.

18. The method of claim 17, wherein the strap includes a first surface and a second surface and forming the outer portion comprises forming the at least one engagement member on the second surface of the strap.

19. The method of claim 18, wherein forming the outer portion comprises forming a rib to encompass the tail portion along the portion of the length of the strap on the first surface of the strap, wherein the barb is configured to engage the longitudinal rib when a force is applied to the strap in a second direction.

20. The method of claim 16, wherein the first material comprises at least one of polypropylene (PP), polyethylene (PE), high-density polyethylene (HDPE), low-density polyethylene (LDPE), and polyethylene terephthalate (PET).
